(19) United States
(12) Patent Application Publication
(10) Pub. No.: US 2024/0256637 A1
(43) Pub. Date: Aug. 1, 2024

(54) Data Classification Using Ensemble Models

(71) Applicant: International Business Machines Corporation, Armonk, NY (US)

(72) Inventors: Si Er Han, Xi'an (CN); Xue Ying Zhang, Xi'an (CN); Jing Xu, Xi'an (CN); Jing James Xu, Xi'an (CN); Xiao Ming Ma, Xi'an (CN); Wen Pei Yu, Xi'an (CN); Jun Wang, Xi'an (CN); Ji Hui Yang, Beijing (CN)

(21) Appl. No.: 18/160,332

(22) Filed: Jan. 27, 2023

(51) Int. Cl. G06F 18/2321; G06F 18/241

(52) U.S. Cl. CPC G06F 18/2321; G06F 16/285; G06F 18/241

(57) ABSTRACT

A computer implemented method manages an ensemble model system to classify records. A number of processor units cluster records into groups of records based on classification predictions generated by base models in the ensemble model system for the records. The number of processor units determines sets of weights for the base models that increase a probability that the base models in the ensemble model system correctly predict the groups of records. Each set of weights in the sets of weights is associated with a group of records in the groups of records.

### BACKGROUND

The disclosure relates generally to an improved computer system and more specifically to classifying data using ensemble models.

Identifying categories or classifications for data can be performed using classification algorithms. Machine learning models have been implemented to perform classification tasks. The classification of data into categories can be performed in a number of different ways. For example, a machine learning model can be trained to classifying data into categories for particular types of data. For example, a machine learning model can be trained to classify images. Another machine learning model can be trained to classify data records.

Multiple machine learning models can be trained and used to classify data as a system. Each of the machine learning models can provide a prediction as to the classification of the data. These predictions can be analyzed to provide a final prediction as to the classification of the data. This use of machine learning to classify data is referred to as ensemble model.

### SUMMARY

According to one illustrative embodiment, a computer implemented method manages an ensemble model system to classify records. A number of processor units cluster records into groups of records based on classification predictions generated by base models in the ensemble model system for the records. The number of processor units determines sets of weights for the base models that increase a probability that the base models in the ensemble model system correctly predict the groups of records. Each set of weights in the sets of weights is associated with a group of records in the groups of records. According to other illustrative embodiments, a computer system and a computer program product for managing an ensemble model to classify records are provided.

### BRIEF DESCRIPTION OF THE DRAWINGS

FIG. 1 is a block diagram of a computing environment in which illustrative embodiments can be implemented;

FIG. 2 is a block diagram of a data environment in accordance with an illustrative embodiment;

FIG. 3 is a workflow diagram illustrating management of an ensemble model system in accordance with an illustrative embodiment;

FIG. 4 is an illustration of a table of classification predictions used to detect redundant base models in accordance with an illustrative embodiment;

FIG. 5 is an illustration of a table of classification predictions used to group records in accordance with an illustrative embodiment;

FIG. 6 is a data flow diagram illustrating classification of a new record by an ensemble model system in accordance with an illustrative embodiment;

FIG. 7 is a flowchart of a process for managing an ensemble model system to classify records in accordance with an illustrative embodiment;

FIG. 8 is a flowchart of a process for determining thresholds in accordance with an illustrative embodiment;

FIG. 9 is a flowchart of a process for reducing redundancy in accordance with an illustrative embodiment;

FIG. 10 is a flowchart of a process for clustering records in accordance with an illustrative embodiment;

FIG. 11 is a flowchart of a process for selecting a selection policy in accordance with an illustrative embodiment;

FIG. 12 is a flowchart of a process for classifying a new record in accordance with an illustrative embodiment;

FIG. 13 is a flowchart of a process for using a set of weights for a group that a new record belongs to a classifying the new record in accordance with an illustrative embodiment; and

FIG. 14 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

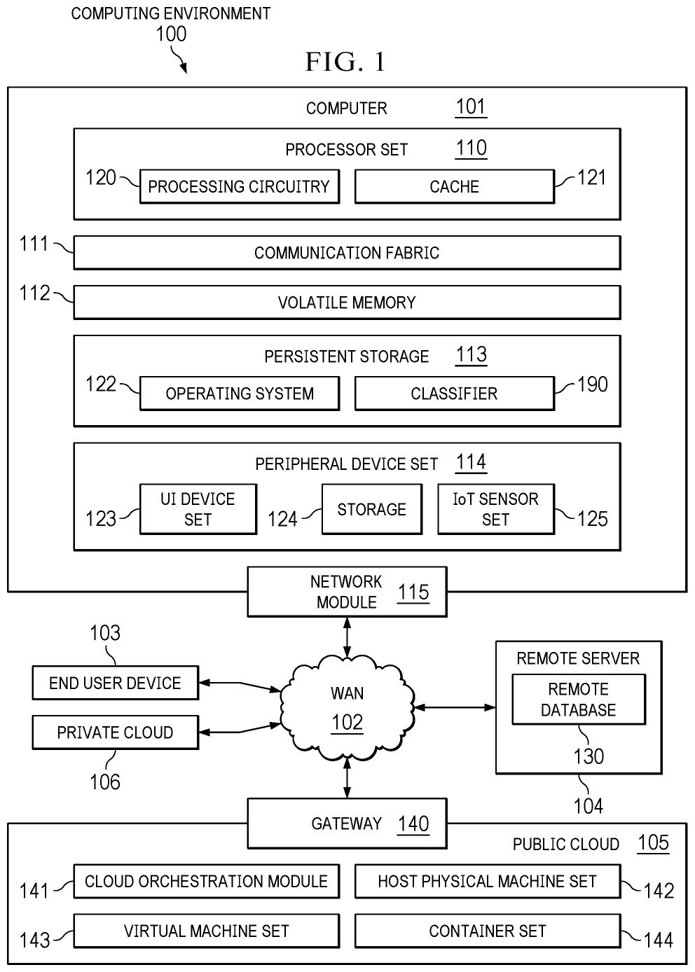

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as classifier 190. In this illustrative example, classifier 190 can create and use ensemble model systems to classify data such as records with improved accuracy over current classifiers. In addition to classifier 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and classifier 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in classifier 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in classifier 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. For example, single machine learning models do not consistently perform as desired when used with different data sets, especially when biased data is present. Ensemble modeling uses multiple machine learning models that classify data in a manner that increases the performance of these classification models.

Multiple diverse models are created to predict a classification for data in an ensemble model system. The ensemble model system aggregates the prediction of each base model into a final prediction. These predictions can be combined using techniques such as boating words mean aggregation.

Although ensemble modeling is useful in increasing the accuracy in classifying data, sometimes a minority prediction of a class can be important but overlooked using current ensemble modeling techniques. For example, a positive case is misclassified by a majority of the models in an ensemble model system as negative in an ensemble modeling system. The final result from the ensemble model system is negative even with of a few strong votes for a positive case from a minority of the models in the ensemble model system.

Thus, illustrative embodiments provide a method, apparatus, system, and computer program product for classifying data using ensemble models. In the different illustrative examples, the different base models are optimized to increase classification accuracy. Redundant base models are removed. Records with similar model prediction probability patterns are clustered into the same group to form clusters of records based on probability that the records in the group will have the same classification. Weights for the models are selected by processing the different groups of records to determine what weights provide the highest accuracy in classifying records in each group of records. A set of weights is created for each group of records. A selection policy for selecting a classification prediction using the classification predictions from the base models can be selected.

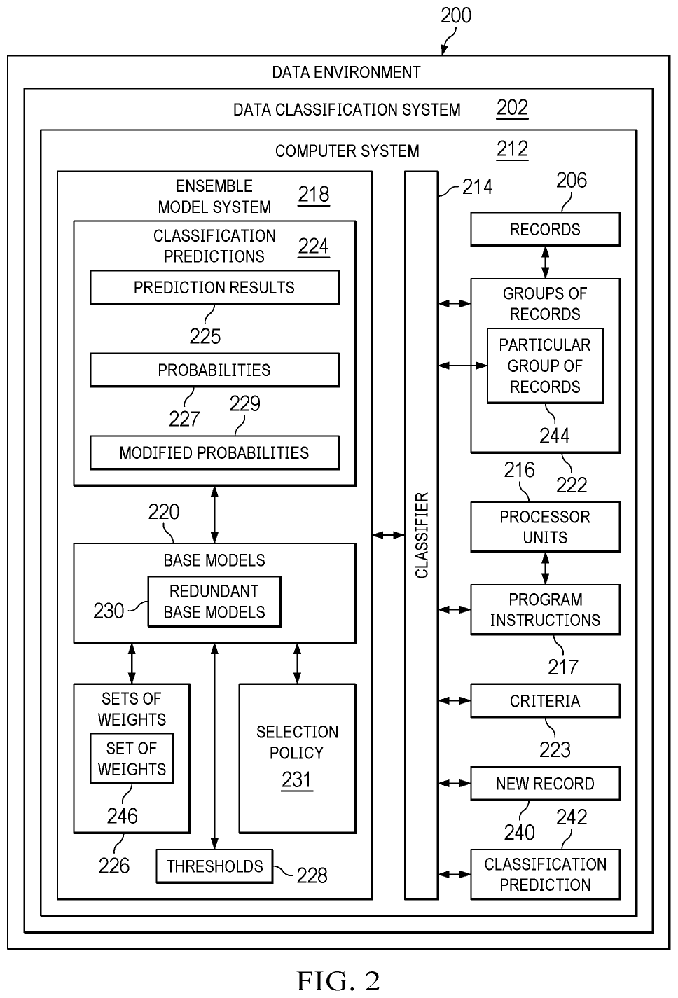

With reference now to FIG. 2, a block diagram of a data environment is depicted in accordance with an illustrative embodiment. In this illustrative example, data environment 200 includes components that can be implemented in hardware such as the hardware shown in computing environment 100 in FIG. 1. In this example, data classification system 202 can classify data in records. In this example, a record is a data structure for a collection of data. A record can have fields with potentially different data types in these fields. Additionally, a record can also be referred to as a member or element in different programming languages.

As depicted, data classification system 202 comprises computer system 212 and classifier 214. In this example, classifier 214 is an example of classifier 190 in FIG. 1.

Classifier 214 can be implemented in software, hardware, firmware or a combination thereof. When software is used, the operations performed by classifier 214 can be implemented in program instructions configured to run on hardware, such as a processor unit. When firmware is used, the operations performed by classifier 214 can be implemented in program instructions and data and stored in persistent memory to run on a processor unit. When hardware is employed, the hardware can include circuits that operate to perform the operations in classifier 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 217 implementing processes in the illustrative examples. In other words, program instructions 217 are computer readable program instructions.

As used herein, a processor unit in the number of processor units 216 is a hardware device and is comprised of hardware circuits such as those on an integrated circuit that respond to and process instructions and program instructions that operate a computer. A processor unit can be implemented using processor set 110 in FIG. 1. When the number of processor units 216 executes program instructions 217 for a process, the number of processor units 216 can be one or more processor units that are on the same computer or on different computers. In other words, the process can be distributed between processor units 216 on the same or different computers in computer system 212.

Further, the number of processor units 216 can be of the same type or different type of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, classifier 214 creates ensemble model system 218 to classify records 206. As depicted, ensemble model system 218 comprises base models 220.

In this example, each base model in base models 220 is a machine learning model. A machine learning model is a type of artificial intelligence model that can learn without being explicitly programmed. A machine learning model can learn based on training data input into the machine learning model. The machine learning model can learn using various types of machine learning algorithms. The machine learning algorithms include at least one of a supervised learning, an unsupervised learning, a feature learning, a sparse dictionary learning, an anomaly detection, a reinforcement learning, a recommendation learning, or other types of learning algorithms. Examples of machine learning models include an artificial neural network, a convolutional neural network, a decision tree, a support vector machine, a regression machine learning model, a classification machine learning model, a random forest learning model, a Bayesian network, a genetic algorithm, and other types of models. These machine learning models can be trained using data and process additional data to provide a desired output.

In this example, the type of machine learning model selected for base models 220 can be of different types and can be selected based on an ability to classify data. In other words, each base model in base models 220 can be a different type of machine learning model from the other machine learning models used for base models 220.

In this illustrative example, classifier 214 clusters the records 206 into groups of records 222 based on classification predictions 224 generated by base models 220 in ensemble model system 218 for records 206. In this example, classification predictions 224 output by base models 220 comprises prediction results 225 for records 206 that include probabilities 227 of prediction results 225. A probability in probabilities 227 indicates a level of confidence in a prediction result in prediction results 225. A prediction result is the classification made by the base model.

Classifier 214 can cluster records 206 into groups by determining classification predictions 224 for records 206 using base models 220 in ensemble model system 218. Classifier 214 can place records 206 into groups of records 222 based on similarities between classification predictions 224. For example, classifier 214 can compare classification predictions 224 and place records 206 into groups of records 222 using a clustering algorithm. The clustering algorithm can be, for example, a K-means clustering algorithm.

In this illustrative example, classifier 214 determines sets of weights 226 for base models 220 that increases a probability that base models 220 in ensemble model system 218 correctly predicts classifications for groups of records 222. In this example, each set of weights in sets of weights 226 is associated with a group of records in groups of records 222.

In this depicted example, a set of weights for a group of records can be selected to increase the accuracy in classifying that group of records. For example, the set of weights can be selected such that base models 220 that correctly make classification predictions 224 for records in the group of records can be given a greater weight as compared to base models 220 that do not correctly classify records in that group of records.

For example, if a first base model classifies a record that is “A” in the group of records as “A” with the probability of 0.51 and a second base model classifies the same record as “B” with a probability of 0.61, weights can be assigned to the first base model and second base model as a set of weights. The weight assigned to the first base model may be, for example, 1.2 to increase the influence of the first base model. The weight assigned to the second base model may be, for example, 0.6 to reduce the influence of the second base model.

In this example, each base model is assigned a weight in the set of weights for the group. Thus, each group of records can have a different set of weights to adjust the influence that particular base models have based on the accuracy of those base models in making classification predictions for records that are identified as being part of that group of records.

In this illustrative example, classifier 214 can determine thresholds 228 for base models 220 that meets a set of criteria 223 for base models 220 in ensemble model system 218. Each base model in base models 220 in ensemble model system 218 has a threshold in thresholds 228 that meets a set of criteria 223. In this example, a threshold can be used to determine the probability that a classification is correct.

Thresholds 228 can be selected to increase the classification accuracy for base models 220 in ensemble model system 218 to meet different criteria in a set of criteria 223. In this example, the set of criteria 223 can take a number of different forms. For example, the set of criteria 223 can be balanced classes, effective target class, the maximum overall accuracy, or other suitable criteria for the classification performed by base models 220. In these illustrative examples, a threshold and the set of thresholds 228 can take a number of different forms. For example, a threshold can be a value, a rule, a function, or some other type of threshold for a set of criteria for the base model.

The selection of thresholds 228 for the set of criteria 223 can be performed using optimization methods. Thresholds selected for a particular base model can be based on meeting the set of criteria 223. For example, a criterion of maximum overall accuracy can be used to select a threshold for the probability that a prediction is correct for classifying a record is correct. As another example, when the criterion is an effective target class, the threshold can be a range of probabilities that increase the ability to detect records in a particular class. The selection of the range of thresholds can result in the sacrifice of accuracy to detect as many records as possible in the class identified in the set of criteria 223.

For example, in making a classification prediction, a base model can generate potential classifications for a record. In this example, the potential classifications are a prediction result of A with a probability of 0.2, a prediction result of B with a probability of 0.39, and prediction result of C with a probability of 0.41.

With this example, if the criterion is maximum overall accuracy, the threshold for selecting the classification prediction from the potential classifications is to select the potential classification with the maximum probability. In this case, the base model outputs a classification prediction with a prediction result C and a probability of 0.41.

In another example, effective target classes are the criteria used for the base model. The threshold for the base model can be a rule stating “A, if Prob A>0.15; else B if Prob B>=Prob C; else C”. With this example, the base model outputs a classification prediction with a prediction result A and a probability of 0.2.

Further, in creating ensemble model system 218, classifier 214 can remove one or more of base models 220 when redundancy is present in the base models 220. For example, classifier 214 can determine whether a set of redundant base models 230 is present in base models 220 in ensemble model system 218. In this illustrative example, a redundant model can be a base model that has a prediction similarity and model type similarity to another base model in base models 220.

For example, a first base model can have a first detection result with a similar probability to a second base model that is of the same model type. The first model can be considered a redundant base model to the second base model. In this example, classifier 214 can remove a set of redundant base models 230 from base models 220 in ensemble model system 218 in response to the set of redundant base models 230 being present.

In another example, the models do not have to be of the same type to be redundant. In this example, two models can be considered redundant when the models are of a different type but have similar prediction behaviors.

Additionally, classifier 214 can select selection policy 231 that uses classification predictions 224 to classify records 206. This selection policy is used in ensemble model system 218 to select classification prediction 242 from classification predictions 224 made by base models 220. In this example, selection policy 231 is a set of rules and can include one or more values. The rules can be logic used to determine the classification prediction 242 using the classification predictions 224 generated by the base models 220. For example, selection policy 231 can include voting, mean aggregation, or some other logical process or rule to select the classification for a record being classified from classification predictions 224 made by base models 220 in ensemble model system 218.

With the determination of sets of weights 226, thresholds 228, and selection policy 231, ensemble model system 218 can be used to classify new records. For example, classifier 214 can receive new record 240 for classification. Classifier 214 determines classification prediction 242 for new record 240 using base models 220 in ensemble model system 218.

In this example, the classification process begins with classifier 214 using base models 220 to generate classification predictions 224 for new record 240. Classifier 214 identifies particular group of records 244 in groups of records 222 most like new record 240. The identification of particular group of records 244 for new record 240 can be made by classifier 214 using classification predictions 224 generated for new record 240 and for groups of records 244.

In this example, classifier 214 associates new record 240 with a group of records in groups of records 222 based on similarities of classification predictions 224 generated from performing classification of new record 240 using base models 220 with classification predictions 224 made for groups of records 222 using base models 220.

For example, classifier 214 can compare classification predictions 224 for new record 240 with classification predictions 224 generated for groups of records 222. The comparison of these classification predictions for the prior groups of records with classification predictions 224 for new record 240 can used to determine which group of records new record 240 belongs to in this example. For example, the distance of new record 240 to the center of each group of records in groups of records 222. New record 240 belongs to the group of records with the shortest distance to new record 24.

With the identification of particular group of records 244 which group new record 240 belongs to in groups of records 222, set of weights 246 for particular group of records 244 is selected for use in determining classification prediction 242 the new record 240. In other words, classifier 214 selects set of weights 246 from sets of weights 226 that correspond to particular group of records 244 that new record 240 is associated with based on comparing results from classifying new record 240 with the results from classifications of groups of records 222. This set of weights is applied to classification predictions 224 generated for new record 240 to determine classification prediction 242 for new record 240.

In this example, probabilities 227 in classification predictions 224 is multiplied by set of weights 246 to obtain modified probabilities 229 for classification predictions 224. This adjustment to the probabilities using set of weights 246 can increase the accuracy in classifying records. These adjustments can be made to increase the weight of a minority classification prediction made by a base model by using weights to increase the probability of the prediction relative to predictions made by other base models that have determined to be not as accurate for that particular group of records. The weights can also be used to decrease the probability of a prediction made by the base models that are not as accurate for the particular group of records identified for new record 240.

Classifier 214 uses selection policy 231 to determine classification prediction 242 from determined classification predictions 224 generated from new record 240.

Thus, increased accuracy can be achieved in classifying records by creating a set of weights that can take into account that a base model may have a minority classification as compared to other base models. A minority classification means that the model outputs a classification that is a minority with respect to the classifications output by other models. The base model with a minority classification can be taken into account when that base model has a strong vote for a particular classification as compared to the other base models that are in the majority that have a lower mode for a classification.

In one illustrative example, one or more technical solutions are present that overcome a technical problem with current techniques for using multiple base models in an ensemble system to classify records in which minority prediction of a class can be important but overlooked using current ensemble modeling techniques. In the illustrative examples, model diversity can be increased and optimized by combining weights and a selection of the selection policy to boost the ability of minority predictions being taken into account. In the illustrative examples, the weights can be selected such that grouping records based on the similarity of records to each other and identify weights for the base models that provide a desired level accuracy for each of the groups of records identified. With this identification of weights based on different groupings of records, the base models can be more accurate in classifying particular types of records in the groupings of records.

When new records are classified, those records are compared to the grouping of records to identify a group of records that is most similar to the new records using the prediction results from classifying the groups of records and the new records. The set of weights for that group identified for the new records are used for performing the classification of the new records. Thus, the classifications from base models that are in the minority can be boosted or increased in weight with the use of the set of weights generated from grouping records to increase accuracy in classifying records. In these examples, the records are placed into groups based on the predictions made by the base models.

Computer system 212 can be configured to perform at least one of the steps, operations, or actions described in the different illustrative examples using software, hardware, firmware or a combination thereof. As a result, computer system 212 operates as a special purpose computer system in which classifier 214 in computer system 212 enables increased accuracy in classifying records. In particular, classifier 214 transforms computer system 212 into a special purpose computer system as compared to currently available general computer systems that do not have classifier 214.

In the illustrative example, the use of classifier 214 in computer system 212 integrates processes into a practical application for managing an ensemble model system to classify records in a manner that increases the performance of computer system 212 in classifying records. In other words, classifier 214 in computer system 212 is directed to a practical application of processes integrated into classifier 214 in computer system 212 that generate weights for use in adjusting the influence of classification predictions made by base models in an ensemble system such that the classification is performed with increased accuracy.

The illustration of data environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, classifier 214 can manage one or more ensemble model systems in addition to ensemble model system 218. These ensemble model systems can be directed at particular types of data sets. As another example, classifier 214 can receive additional new records in addition to new record 240 and process these new records using ensemble model system 218. In some illustrative examples, optimizing thresholds 228 from base models 220 can be omitted. In another illustrative example, the removal of redundant base models 230 can be omitted with ensemble model system 218 still having greater accuracy as compared to current techniques.

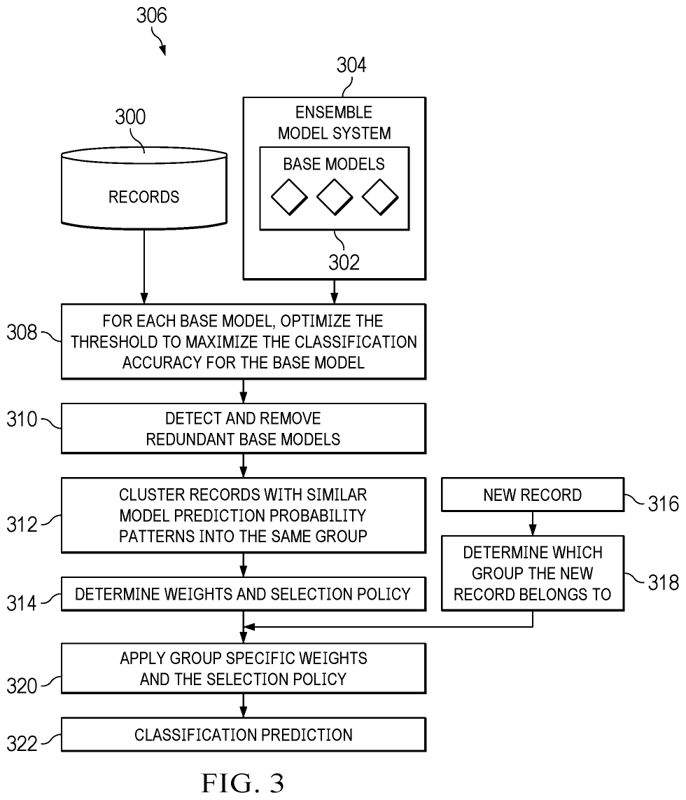

With reference now to FIG. 3, a workflow diagram illustrating management of an ensemble model system is depicted in accordance with an illustrative embodiment. In this example, workflow 306 can be implemented in classifier 214 in FIG. 2.

As depicted, records 300 and base models 302 for ensemble model system 304 are inputs to workflow 306. In this example, records 300 are data that can be classified by base models 302.

For each base model, workflow 306 optimizes the threshold to maximize the classification accuracy for the base model (block 308). In block 308, workflow 306 can use various optimization techniques to increase the accuracy of individual base models in base models 302 in classifying records 300. For example, one optimization method that can be used is gradient descent. In this example, the threshold for each base model can be adjusted to maximize its own classification accuracy.

Next, workflow 306 detects and removes redundant base models (block 310). In block 310, models are redundant when models are of the same type and have prediction results that are within a threshold of each other. The threshold of how close prediction results can be, for example, plus or minus 0.2 on a scale of 0 to 1. In other examples, redundant base models can be of different types but have similar prediction results that are within a threshold with each other.

Workflow 306 clusters records 300 with similar model prediction probability patterns into the same group (block 312). This grouping of records can be performed using the predictions made by the base models. For example, a clustering algorithm can use the predictions to generate the groups of records in block 312.

Next, workflow 306 determines weights and selection policy (block 314). In block 314, weights for each base model are determined to increase the accuracy in predicting records based on the group of records. For example, the base models can have a first set of weights used to predict records in a first group and the base models can have a second set of weights used to predict records in the second group. These two sets of weights are different from each other and are selected to increase the accuracy in classifying records of the type in the different groups. These weights are applied to the probabilities for prediction results output by the base models.

A selection policy is also created are selected for selecting a prediction result and probability based on the prediction results in probabilities generated by the base models. In this example, the probabilities used by the selection policy are adjusted probabilities based on the weights.

At this point in workflow 306, ensemble model system 304 can be used to classify records with increased accuracy. For example, in response to receiving new record 316 is received for classification, new record 316 is analyzed to determine which group the new record belongs to (block 318). In block 318, new record 316 is sent to base models 302 to obtain classification predictions. The classification predictions for new record 316 can be compared to the classification predictions representative of each group created in block 312.

In response to determining the group for new record 316, workflow 306 can apply group specific weights and the selection policy to classify new record 316 (block 320). In block 320, the group specific weights are weights for the group identified as being most like new record 316. With the application of group specific weights for the group most like new record 320, workflow 306 generates classification prediction 322 using ensemble model system 304 (block 322).

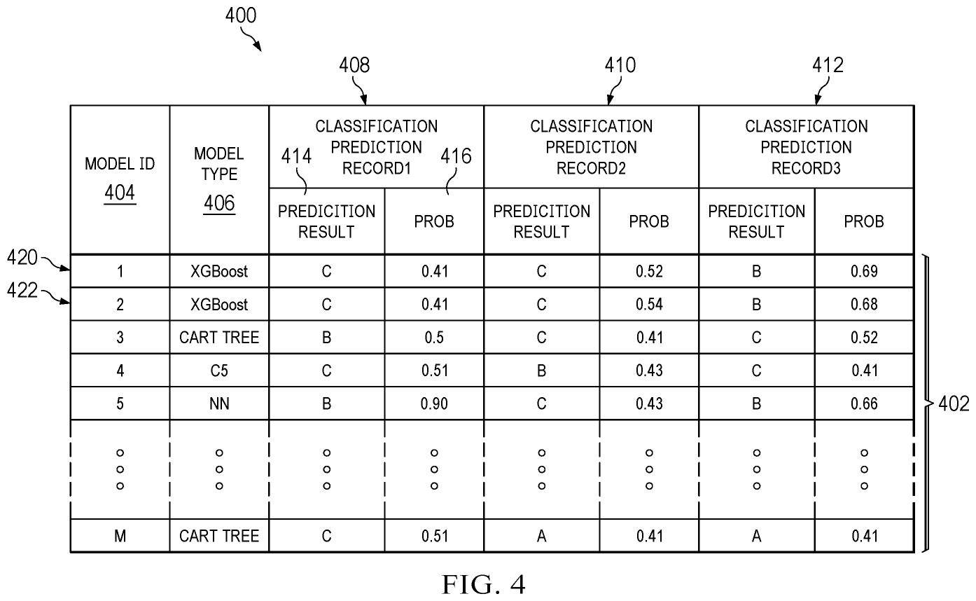

With reference to FIG. 4, an illustration a table of classification predictions used to detect redundant base models is depicted in accordance with an illustrative embodiment. In this illustrative example, table 400 contains base models and predictions for records. As depicted, rows 402 in table 400 are entries for base models.

In this example, column 404 is a model identifier for a base model, column 406 is a model type for a base model. Column 408 is a classification prediction for Record 1, column 410 is a classification prediction for Record 2, and column 412 is a classification prediction for Record 3.

Each of these three columns has subcolumns identifying a prediction result and the probability of the prediction result. For example, column 408 has subcolumn 414 for a prediction result and subcolumn 416 for a probability of the prediction result.

As depicted, the base model in row 420 and the base model in row 422 are sufficiently similar to each other to be considered redundant base models. In this example, both of these base models are of the same type and generate the same prediction result for Record 1, Record 2, and Record 3. Further in this example, both have probabilities that are sufficiently close to each other. In this example one of these two base models can be removed as a redundant base model.

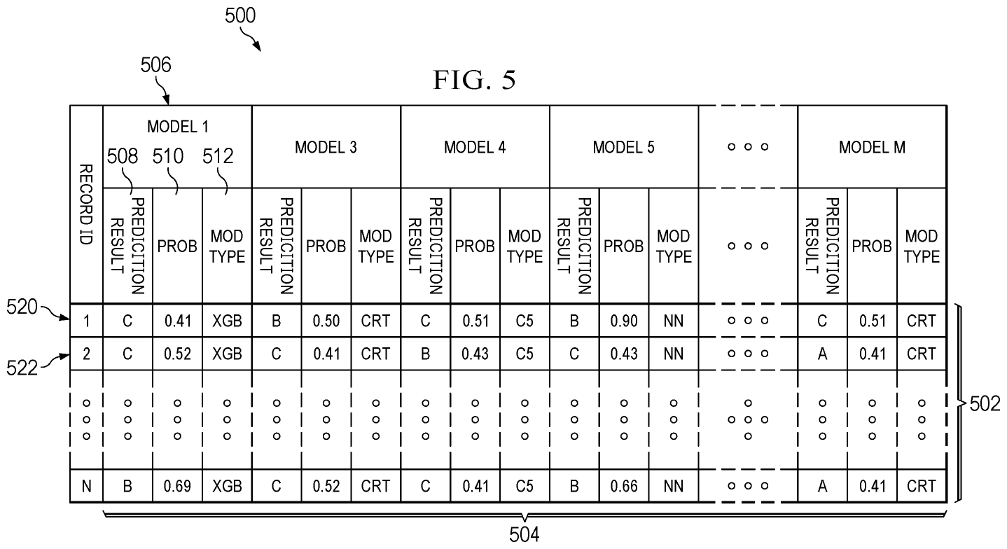

Turning to FIG. 5, a table of classification predictions used to group records is depicted in accordance with an illustrative embodiment. In this illustrative example, table 500 contains records and classifications of records by base models. As depicted, rows 502 are entries for records.

In this example, columns 504 represent models. Each of these columns as a subcolumn representing the prediction result, the probability of the prediction result, and the model type. For example, column 506 is for Model 1 and has subcolumn 508 for the prediction result, subcolumn 510 for the probability of the prediction result, and subcolumn 512 for the model type.

Row 520 for Record 1 and row 522 for Record 2 are sufficiently similar to each other based on the classification predictions performed by Model 1. As depicted, both records had the prediction result classifying both records as “C” and the probability is sufficiently close to each other in this example. As depicted, the other models do not generate the same prediction result as Model 1 Record 1 in row 520 and Record 2 in row 522.

In this example, Record 1 and Record 2 are placed in the group for Model 1. With this grouping of records, a set of weights for Model 1 can be adjusted or created to increase the accuracy in classifying Record 1 and Record 2. For example, the weights can be adjusted such that the probability increases when Model 1 classifies Record 1 and Record 2 as “C”. For example, by adjusting the set of weights for Model 1 the probabilities can be increased from 0.41 to 0.9 in classifying Record 1 as “C” and from 0.51 to 0.93 in classifying Record 2 as “C”. As a result, a set of weights can be created for Model 1 that provides increased accuracy classifying records that are similar to Record 1 and Record 2.

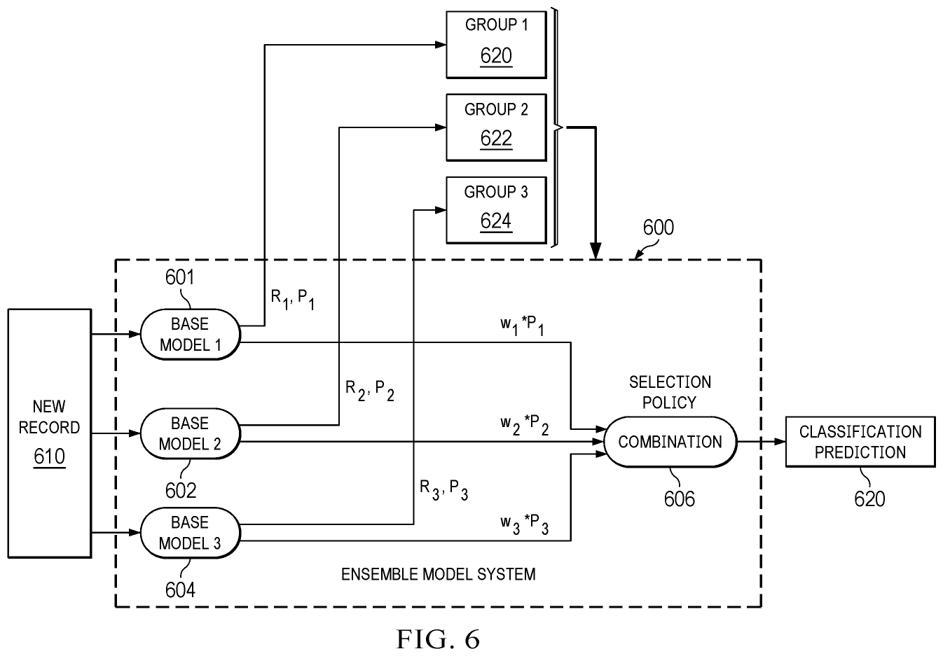

Turning next to FIG. 6, a data flow diagram illustrating classification of a new record by an ensemble model system is depicted in accordance with an illustrative embodiment. In this example, ensemble model system 600 is an example of ensemble model system 218 in FIG. 2. As depicted, ensemble model system 600 comprises three base models, Base Model 1 601, Base Model 2 602, and Base Model 3 604. In this example, ensemble model system 600 also includes combination 606. This takes predictions from the base models and generates a final prediction using the predictions from the base models.

As depicted, ensemble model system 600 receives new record 610 for classification. In this example, new record 610 is sent to all three of the base models. These base models generate classification predictions in response to receiving new record 610.

As depicted, the classification of new record 610 by Base Model 1 601 generates a classification prediction comprising prediction result R1 and probability P1. Base Model 2 602 generates a classification prediction comprising prediction result R2 and probability P2 for new record 610, and Base Model 3 604 generates a classification prediction comprising prediction result R3 and probability P3 for new record 610.

These base model outputs can be used to determine a group for new record 610. For example, these prediction results and probabilities are compared with prediction results and probabilities for the groups of records associated with the base models. In this example, Group 1 620, Group 2 622 Group 3 624 are groups of records that are identified by grouping records that are similar to each other. These groupings can made by using a clustering algorithm.

In this example, new record 610 can be associated with a group by comparing the prediction result and probability in the classification prediction for new record 610 with the prediction results and probabilities in the classification predictions for the different groups. Once a group is identified for new record 610, the set of weights for that group are selected for use in adjusting the probabilities from the classification predictions for new record 610. In this example, the set of weights includes a weight for each of the base models.

In this illustrative example, the classification of a record using the set of weights involves multiplying the probabilities of the classification results by the set of weights for the group identified for new record 610. For example, if new record 610 belongs to Group 1 620, the set of weights for this group is w1, w2, and w3. The probabilities for the prediction results made by these base models can be modified by multiplying the set of weights with the probabilities as follows: R1, w1*P1, w2*P2, and w3*P3. As a result, modified probabilities are obtained that change the influence of different base models to provide a more accurate result when the different prediction results are processed by combination 606. Combination 606 implements a selection policy to select a prediction result to output as classification prediction 620 for new record 610.

In another illustrative example, if multiple records are present and those records correspond to different groups, the sets of weights are selected adjusting the probabilities of the prediction results for use by combination 606 to classify those records. In this manner, weighting of the classification results can be made in a manner that increases accuracy in classifying records.

The illustration of ensemble model system 600 in FIG. 6 is presented as a single illustration to show data flow in classifying a record. This illustration is not meant to limit the manner in which other illustrative examples can be implemented. For example, in other illustrative examples other numbers of base models can be present in addition to the three base models depicted for ensemble model system 600. For example, 2 base models, 24 base models, 250 base models, or some other number of base models can be present in an ensemble model system. Additionally, different numbers of groups can be present other than the three groups depicted in this example. The number groups present can depend on how the records initially used to create the sets of weights for ensemble model system 600 are grouped.

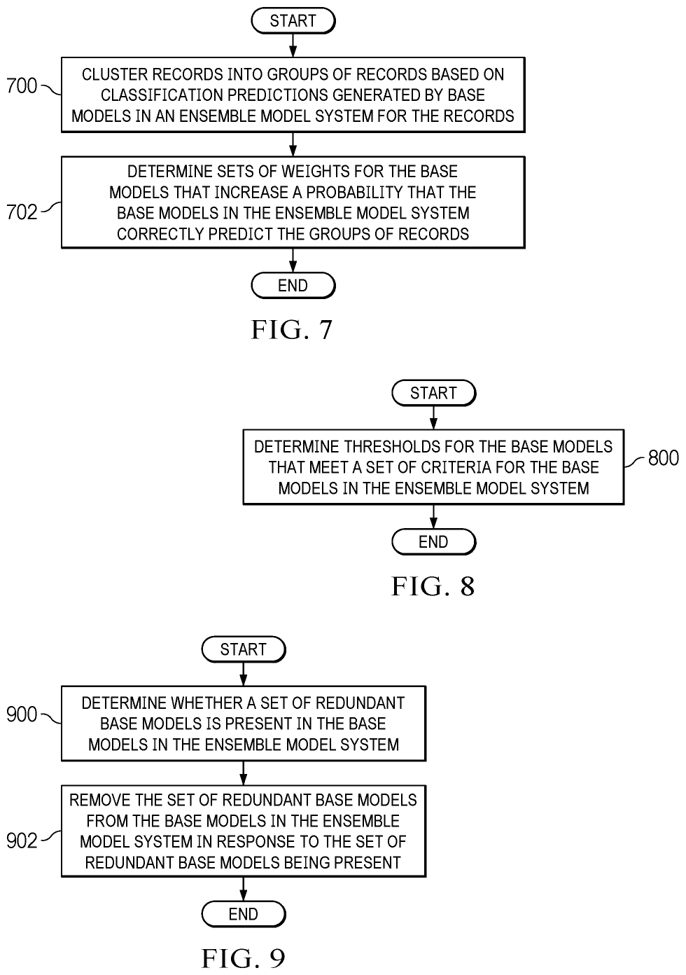

Turning next to FIG. 7, a flowchart of a process for managing an ensemble model system to classify records is depicted in accordance with an illustrative embodiment. The process in FIG. 7 can be implemented in hardware, software, or both. When implemented in software, the process can take the form of program instructions that are run by one of more processor units located in one or more hardware devices in one or more computer systems. For example, the process can be implemented in classifier 214 in computer system 212 in FIG. 2.

The process begins by clustering the records into groups of records based on classification predictions generated by base models in an ensemble model system for the records (step 700). In step 700, a group of records in the groups of records are clustered together based on the similarity of those records to each other.

The process determines sets of weights for the base models that increase a probability that the base models in the ensemble model system correctly predict the groups of records (step 702). The process terminates thereafter. In step 702, each set of weights in the sets of weights is associated with a group of records in the groups of records. In other words, a set of weights is selected to optimize the probability to correctly predict a classification for a group of records in the groups of records. The set of weights are used to modify the probabilities of prediction results in classification predictions performed by the base models. These weights are used to provide increased influence for base models that correctly classify records in a particular group of records. The weights can also be used to decrease influence by base models that incorrectly classify records in the group of records.

In these examples, each base model is assigned a weight. In some illustrative examples, weights may be only assigned to increase the influence of base models or weights may be assigned to only decrease the influence of base models. In other words, depending on the particular implementation, only some of the base models may have weights for adjusting the probabilities in their classification predictions.

With reference now to FIG. 8, a flowchart of a process for determining thresholds is depicted in accordance with an illustrative embodiment. The process in FIG. 8 is an example of an additional step that can be performed with the steps in FIG. 7.

The process determines thresholds for the base models that meet a set of criteria for the base models in the ensemble model system (step 800). The process terminates thereafter. In step 800 each base model in the base models in the ensemble model system has a threshold in the thresholds that meets a set of criteria.

With reference now to FIG. 9, a flowchart of a process for reducing redundancy is depicted in accordance with an illustrative embodiment. The process in FIG. 9 is an example of additional steps that can be performed with the steps in FIG. 7. This process can remove influence by a particular type of base model that occurs from additional numbers of this type of redundancy being present.

The process begins by determining whether a set of redundant base models is present in the base models in the ensemble model system (step 900). The process removes the set of redundant base models from the base models in the ensemble model system in response to the set of redundant base models being present (step 902). The process terminates thereafter.

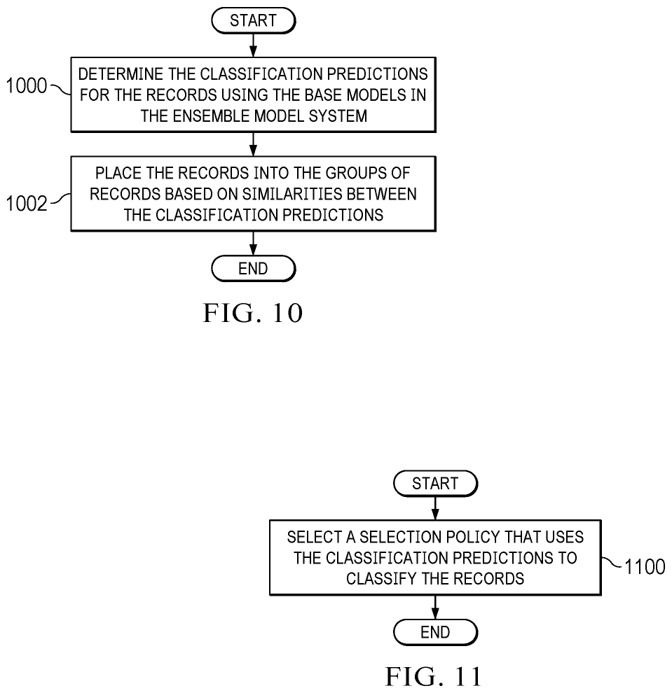

Turning to FIG. 10, a flowchart of a process for clustering records is depicted in accordance with an illustrative embodiment. The process in FIG. 10 is an example of an implementation for step 700 in FIG. 7.

The process begins by determining the classification predictions for the records using the base models in the ensemble model system (step 1000). The process places the records into the groups of records based on similarities between the classification predictions (step 1002). The process terminates thereafter. In step 1002, the process looks at the similarity of the classifications and probabilities with classifications as part of looking at the similarity of the classification predictions.

With reference now to FIG. 11, a flowchart of a process for selecting a selection policy is depicted in accordance with an illustrative embodiment. The process in FIG. 8 is an example of an additional step that can be performed with the steps in FIG. 7.

The process selects a selection policy that uses the classification predictions to classify the records (step 1100). The process terminates thereafter. In step 1100, the selection policy is a set of rules and can include one or more values used to determine the final classification prediction using the classification predictions generated by the base models.

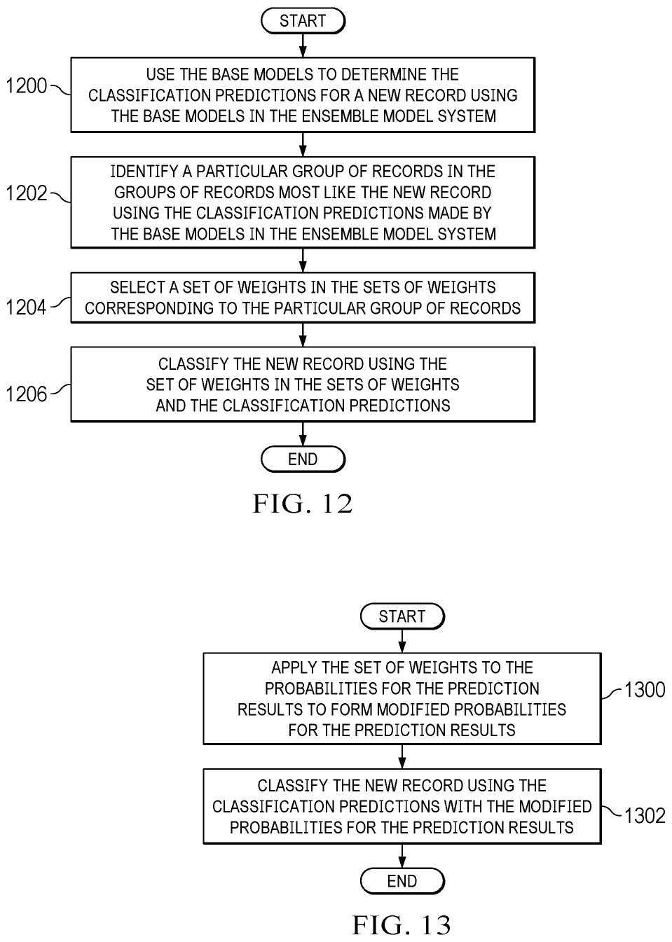

With reference now to FIG. 12, a flowchart of a process for classifying a new record is depicted in accordance with an illustrative embodiment. The process in FIG. 12 is an example of an additional step that can be performed with the steps in FIG. 7. This process can be used to classify a new record after the creation or modification of ensemble model system 218 in FIG. 2.

The process begins by using the base models to determine the classification predictions for a new record using the base models in the ensemble model system (step 1200). The process identifies a particular group of records in the groups of records most like the new record using the classification predictions made by the base models in the ensemble model system (step 1202). In step 1202, the determination of what group a new record belongs to can be performed in a number of different ways. For example, the distance between this new record to the center of each group can be determined. These distance values for the groups can be analyzed to identify the group with shortest distance between the center of the group and the new record. The new record belongs to the group with the shortest distance in this example.

The process selects a set of weights in the sets of weights corresponding to the particular group of records (step 1204). The process classifies the new record using the set of weights in the sets of weights and the classification predictions (step 1206). The process terminates thereafter.

In FIG. 13, a flowchart of a process for using set of weights for a group that a new record belongs to a classifying the new record is depicted in accordance with an illustrative embodiment. The process in FIG. 13 is an example of an implementation of step 1206 in FIG. 12.

The process begins by applying the set of weights to the probabilities for the prediction results to form modified probabilities for the prediction results (step 1300). The process classifies the new record using the classification predictions with the modified probabilities for the prediction results (step 1302). The process terminates thereafter. In this manner, the weight of a classification prediction made by a base model can be influenced or boosted if the base model accurately classifies records in the group for the new record. In other examples, weight of a classification prediction made by a base model can be decreased if the base model does not accurately classify records in the group.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

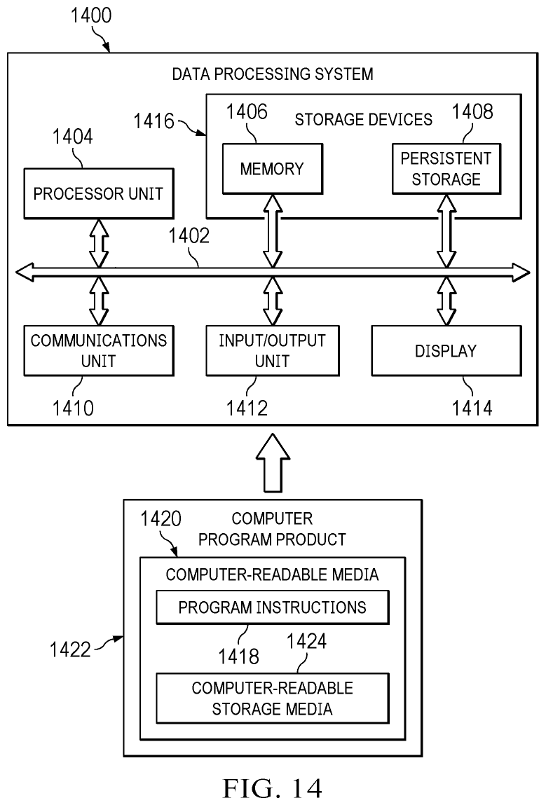

Turning now to FIG. 14, a block diagram of a data processing system is depicted in accordance with an illustrative embodiment. Data processing system 1400 can be used to implement computers and computing devices in computing environment 100 in FIG. 1. Data processing system 1400 can also be used to implement computer system 212 in FIG. 2. In this illustrative example, data processing system 1400 includes communications framework 1402, which provides communications between processor unit 1404, memory 1406, persistent storage 1408, communications unit 1410, input/output (I/O) unit 1412, and display 1414. In this example, communications framework 1402 takes the form of a bus system.

Processor unit 1404 serves to execute instructions for software that can be loaded into memory 1406. Processor unit 1404 includes one or more processors. For example, processor unit 1404 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1404 can be implemented using one or more heterogeneous processor systems in which a main processor is present with secondary processors on a single chip. As another illustrative example, processor unit 1404 can be a symmetric multi-processor system containing multiple processors of the same type on a single chip.

Memory 1406 and persistent storage 1408 are examples of storage devices 1416. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1416 may also be referred to as computer readable storage devices in these illustrative examples. Memory 1406, in these examples, can be, for example, a random-access memory or any other suitable volatile or non-volatile storage device. Persistent storage 1408 may take various forms, depending on the particular implementation.

For example, persistent storage 1408 may contain one or more components or devices. For example, persistent storage 1408 can be a hard drive, a solid-state drive (SSD), a flash memory, a rewritable optical disk, a rewritable magnetic tape, or some combination of the above. The media used by persistent storage 1408 also can be removable. For example, a removable hard drive can be used for persistent storage 1408.

Communications unit 1410, in these illustrative examples, provides for communications with other data processing systems or devices. In these illustrative examples, communications unit 1410 is a network interface card.

Input/output unit 1412 allows for input and output of data with other devices that can be connected to data processing system 1400. For example, input/output unit 1412 may provide a connection for user input through at least one of a keyboard, a mouse, or some other suitable input device. Further, input/output unit 1412 may send output to a printer. Display 1414 provides a mechanism to display information to a user.

Instructions for at least one of the operating system, applications, or programs can be located in storage devices 1416, which are in communication with processor unit 1404 through communications framework 1402. The processes of the different embodiments can be performed by processor unit 1404 using computer-implemented instructions, which may be located in a memory, such as memory 1406.

These instructions are referred to as program instructions, computer usable program instructions, or computer readable program instructions that can be read and executed by a processor in processor unit 1404. The program instructions in the different embodiments can be embodied on different physical or computer readable storage media, such as memory 1406 or persistent storage 1408.

Program instructions 1418 is located in a functional form on computer readable media 1420 that is selectively removable and can be loaded onto or transferred to data processing system 1400 for execution by processor unit 1404. Program instructions 1418 and computer readable media 1420 form computer program product 1422 in these illustrative examples. In the illustrative example, computer readable media 1420 is computer readable storage media 1424.

Computer readable storage media 1424 is a physical or tangible storage device used to store program instructions 1418 rather than a medium that propagates or transmits program instructions 1418. Computer readable storage media 1424, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1418 can be transferred to data processing system 1400 using a computer readable signal media. The computer readable signal media are signals and can be, for example, a propagated data signal containing program instructions 1418. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1420” can be singular or plural. For example, program instructions 1418 can be located in computer readable media 1420 in the form of a single storage device or system. In another example, program instructions 1418 can be located in computer readable media 1420 that is distributed in multiple data processing systems. In other words, some instructions in program instructions 1418 can be located in one data processing system while other instructions in program instructions 1418 can be located in one data processing system. For example, a portion of program instructions 1418 can be located in computer readable media 1420 in a server computer while another portion of program instructions 1418 can be located in computer readable media 1420 located in a set of client computers.

The different components illustrated for data processing system 1400 are not meant to provide architectural limitations to the manner in which different embodiments can be implemented. In some illustrative examples, one or more of the components may be incorporated in or otherwise form a portion of, another component. For example, memory 1406, or portions thereof, may be incorporated in processor unit 1404 in some illustrative examples. The different illustrative embodiments can be implemented in a data processing system including components in addition to or in place of those illustrated for data processing system 1400. Other components shown in FIG. 14 can be varied from the illustrative examples shown. The different embodiments can be implemented using any hardware device or system capable of running program instructions 1418.

Thus, illustrative embodiments of the present invention provide a computer implemented method, computer system, and computer program product for managing an ensemble model system to classify records. A number of processor units cluster records into groups of records based on classification predictions generated by base models in the ensemble model system for the records. The number of processor units determines sets of weights for the base models that increase a probability that the base models in the ensemble model system correctly predict the groups of records. Each set of weights in the sets of weights is associated with a group of records in the groups of records.

In the illustrative examples, groups of records are identified based on the classification predictions made by the base models in the ensemble model system. The classification predictions are used to determine sets of weights for the groups of records. A set of weights is determined for each group of records. A set of weights for a group of records is selected such that a probability that a correct classification of the group of records is made by the base models in the ensemble model system.

In response to receiving a new record for classification, classification predictions are made for that new record using the base models. These classification predictions are used to associate the new record with a group. In other words, a determination is made as to what group the record belongs to for additional processing. This determination can be made by comparing the prediction results and the probabilities in the classification predictions with those for the groups of records.

When a group is identified, the set of weights is used to adjust the probabilities for the prediction results in the classification predictions made for the new record. These adjusted probabilities for the prediction results are then used to determine a classification prediction from the classification predictions for the new record.

With this weighting of prediction results, the influence of base models that that are less likely to correctly classify records in the group associated with the new record can be reduced while the influence of base models that are more likely to correctly classify records in the group can be increased. As a result, a minority classification result can have increased influence and probability of being selected with a higher weighting of its probability. In this manner, a situation in which a positive case is misclassified by a majority of the base classifiers as negative can be overcome through weighting the probabilities of the prediction results using weights based on groups of records.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

1. A computer implemented method, the computer implemented method comprising:
clustering, by a number of processor units, records into groups of records based on classification predictions generated by base models in an ensemble model system for the records; and
determining, by the number of processor units, sets of weights for the base models that increase a probability that the base models in the ensemble model system correctly predict the groups of records, wherein each set of weights in the sets of weights is associated with a group of records in the groups of records.

2. The computer implemented method of claim 1 further comprising:
determining, by the number of processor units, the classification predictions for the records using the base models in the ensemble model system; and
determining, by the number of processor units, thresholds for the base models that meets a set of criteria for the base models in the ensemble model system, wherein each base model in the base models in the ensemble model system has a threshold in the thresholds that meets a set of criteria.

3. The computer implemented method of claim 1 further comprising:
determining, by the number of processor units, the classification predictions for the records using the base models in the ensemble model system;
determining, by the number of processor units, whether a set of redundant base models is present in the base models in the ensemble model system, wherein a given redundant model in the set of redundant base models has a prediction similarity and model type similarity to another base model of the base models; and
removing, by the number of processor units, the set of redundant base models from the base models in the ensemble model system in response to the set of redundant base models being present.

4. The computer implemented method of claim 1, further comprising:
determining, by the number of processor units, the classification predictions for the records using the base models in the ensemble model system;
wherein clustering, by the number of processor units, records into groups of records based on the classification predictions generated by base models in the ensemble model system for the records comprises:
determining, by the number of processor units, the classification predictions for the records using the base models in the ensemble model system; and
placing, by the number of processor units, the records into the groups of records based on similarities between the classification predictions.

5. The computer implemented method of claim 1 further comprising:
determining, by the number of processor units, the classification predictions for the records using the base models in the ensemble model system; and
selecting, by the number of processor units, a selection policy that uses the classification predictions to classify the records.

6. The computer implemented method of claim 1 further comprising:
determining, by the number of processor units, the classification predictions for the records using the base models in the ensemble model system;
using, by the number processor units, the base models to determine classification predictions for a new record using the base models in the ensemble model system;
identifying, by the number processor units, a particular group of records in the groups of records most like the new record using based on the classification predictions made by the base models in the ensemble model system;
selecting, by the number processor units, a set of weights in the sets of weights corresponding to the particular group of records; and
classifying the new record using the set of weights in the sets of weights and the classification predictions.

7. The computer implemented method of claim 6, wherein classifying the new record using the base models in the ensemble model system using the set of weights in the sets of weights comprises:
applying, by the number processor units, the set of weights to the probabilities for the prediction results to form modified probabilities for the prediction results; and
classifying, by the number processor units, the new record using the classification predictions with the modified probabilities for the prediction results.

8. A computer system comprising:
a number of processor units, wherein the number of processor units executes program instructions to:
cluster records into groups of records based on classification predictions generated by base models in the ensemble model system for the records; and
determine sets of weights for the base models that increase a probability that the base models in the ensemble model system correctly predict the groups of records, wherein each set of weights in the sets of weights is associated with a group of records in the groups of records.

9. The computer system of claim 8, wherein the number of processor units executes the program instructions to:
determine the classification predictions for the records using the base models in the ensemble model system; and
determine thresholds for the base models that meets a set of criteria for the base models in the ensemble model system, wherein each base model in the base models in the ensemble model system has a threshold in the thresholds that meets a set of criteria.

10. The computer system of claim 8, wherein the number of processor units executes the program instructions to:
determine the classification predictions for the records using the base models in the ensemble model system;
determine whether a set of redundant base models is present in the base models in the ensemble model system, wherein a given redundant model in the set of redundant base models has a prediction similarity and model type similarity to another base model of the base models; and
remove the set of redundant base models from the base models in the ensemble model system in response to the set of redundant base models being present.

11. The computer system of claim 8, further comprising:
determine the classification predictions for the records using the base models in the ensemble model system;
wherein in clustering records into groups of records based on the classification predictions generated by base models in the ensemble model system for the records, the number of processor units executes the program instructions to:
determine the classification predictions for the records using the base models in the ensemble model system; and
place the records into the groups of records based on similarities between the classification predictions.

12. The computer system of claim 8, wherein the number of processor units executes the program instructions to:
determine the classification predictions for the records using the base models in the ensemble model system; and
select a selection policy that uses the classification predictions to classify the records.

13. The computer system of claim 8, wherein the number of processor units executes the program instructions to:
determine the classification predictions for the records using the base models in the ensemble model system;
use the base models to determine a classification prediction for a new record using the base models in the ensemble model system;
identify a particular group of records in the groups of records most like the new record based on the classification predictions made by the base models in the ensemble model system;
select a set of weights in the sets of weights corresponding to the particular group of records; and
classify the new record using the set of weights in the sets of weights and the classification predictions.

14. The computer system of claim 13, wherein in classifying the new record using the set of weights in the sets of weights and the classification predictions, the number of processor units executes the program instructions to:
apply the set of weights to the probabilities for the prediction results to form modified probabilities for the prediction results; and
classify the new record using the classification predictions with the modified probabilities for the prediction results.

15. A computer program product, the computer program product comprising a computer readable storage medium having program instructions embodied therewith, the program instructions executable by a computer system to cause the computer system to perform a method of:
clustering, by a number of processor units, records into groups of records based on classification predictions generated by base models in an ensemble model system for the records; and
determining, by the number of processor units, sets of weights for the base models that increase a probability that the base models in the ensemble model system correctly predict the groups of records, wherein each set of weights in the sets of weights is associated with a group of records in the groups of records.

16. The computer program product of claim 15 further comprising:
determining, by the number of processor units, the classification predictions for the records using the base models in the ensemble model system; and
determining, by the number of processor units, thresholds for the base models that meets a set of criteria for the base models in the ensemble model system, wherein each base model in the base models in the ensemble model system has a threshold in the thresholds that meets a set of criteria.

17. The computer program product of claim 15 further comprising:
determining, by the number of processor units, the classification predictions for the records using the base models in the ensemble model system;
determining, by the number of processor units, whether a set of redundant base models is present in the base models in the ensemble model system, wherein a given redundant model in the set of redundant base models has a prediction similarity and model type similarity to another base model of the base models; and
removing, by the number of processor units, the set of redundant base models from the base models in the ensemble model system in response to the set of redundant base models being present.

18. The computer program product of claim 15, further comprising:
determining, by the number of processor units, the classification predictions for the records using the base models in the ensemble model system;
wherein clustering, by the number of processor units, records into groups of records based on the classification predictions generated by base models in the ensemble model system for the records comprises:
determining, by the number of processor units, the classification predictions for the records using the base models in the ensemble model system; and
placing, by the number of processor units, the records into the groups of records based on similarities between the classification predictions.

19. The computer program product of claim 15 further comprising:
determining, by the number of processor units, the classification predictions for the records using the base models in the ensemble model system; and
selecting, by the number of processor units, a selection policy that uses the classification predictions to classify the records.

20. The computer program product of claim 15 further comprising:
determining, by the number of processor units, the classification predictions for the records using the base models in the ensemble model system;
using the base models to determine a classification prediction for a new record using the base models in the ensemble model system;
identifying a particular group of records in the groups of records most like the new record based on the classification predictions made by the base models in the ensemble model system;
selecting a set of weights in the sets of weights corresponding to the particular group of records; and
classifying the new record using the base models in the ensemble model system using the set of weights in the sets of weights.
